(19) United States
(12) Patent Application Publication
(10) Pub. No.: US 2011/0088509 A1
(43) Pub. Date: Apr. 21, 2011

(54) DOUBLE-CLUTCH TRANSMISSION FOR VEHICLES

(75) Inventors: Mikael MOHLIN, Kungalv (SE); Axel GEIBERGER, Mainz (DE); Mathias REMMLER, Mauchenheim (DE); Markus ROCKENBACH, Schweppenhausen (DE)

(73) Assignee: GM GLOBAL TECHNOLOGY OPERATIONS, INC., Detroit, MI (US)

(21) Appl. No.: 12/836,473

(22) Filed: Jul. 14, 2010

(30) Foreign Application Priority Data
Jul. 17, 2009 (GB) 0912410.8

(51) Int. Cl. F16H 3/093

(52) U.S. Cl. 74/665 E

(57) ABSTRACT

A double-clutch transmission includes, but is not limited to two input shafts and three layshafts that are parallel to each other. One or more of the layshafts comprises a pinion that meshes with an output gearwheel on an output shaft. Gearwheels are arranged on the shafts and the shafts comprise seven gearwheel groups for providing seven sequentially increasing forward gear speeds. Each of the gearwheel groups comprises a fixed gearwheel on one of the input shafts, meshing with an idler gearwheel on one of the layshafts. One or more coupling devices of the double-clutch transmission is mounted on one of the layshafts to selectively engage one of the idler gears for outputting these seven gear speeds. Especially, the pinion comprises a first pinion mounted on a first layshaft via a bearing.

### CROSS-REFERENCE TO RELATED APPLICATION

This application claims priority to British Patent Application No. 0912410.8, filed Jul. 17, 2009, which is incorporated herein by reference in its entirety.

### TECHNICAL FIELD

The present application relates to a double-clutch transmission for vehicles, such as cars.

### BACKGROUND

A double-clutch transmission (DCT) comprises two input shafts that are connected to and actuated by two clutch discs separately. The two clutch discs are often integrated into a single device that permits actuating any of the two input shafts at one time. The two clutch discs transmit driving torque from an engine to the two input shafts for driving a car.

The DCT has not yet been widely used in cars for street driving. Problems that hinder wide acceptance of the DCT for street driving include providing a compact, reliable, and fuel-efficient DCT. Therefore, there exists a need for providing such a DCT that is also affordable by consumers.

### SUMMARY

Embodiments of the present application provides a DCT that comprises an inner input shaft and an outer input shaft. The inner input shaft is inserted inside the outer input shaft such that the outer input shaft surrounds a portion of the inner input shaft in a radial direction. The radial direction indicates regions that surround a longitudinal axis of the inner input shaft. The outer input shaft can be a hollow input shaft and the inner input shaft can be a solid input shaft. Alternatively, the inner input shaft can also be a hollow input shaft. The inner input shaft is held together with outer input shaft by bearings such that they share the same longitudinal axis of rotation and become one single assembly.

The DCT further comprises a first layshaft, a second layshaft and a third layshaft spaced apart from the input shafts. These layshafts are parallel to the input shafts. A pinion is mounted on one or more of the layshafts and it meshes with an output gearwheel on an output shaft. The pinion serves as a final drive that outputs a drive torque to a drive train of a vehicle. The drive train can alternatively be referred as powertrain or powerplant that comprises the group of components for generating power and for delivering it to the road surface, water, or air. The drive train can include an engine, a transmission, drive shafts, differentials, and a final drive. The final drive can include drive wheels, or continuous track that is used in tanks or caterpillar tractors, or propeller.

Gearwheels of the DCT are arranged these shafts, that include the first layshaft, the second layshaft, the third layshaft, the inner input shaft and the outer input shaft. These gearwheels comprise a first gearwheel group, a second gearwheel group, a third gearwheel group, a fourth gearwheel group, a fifth gearwheel group, a sixth gearwheel group and a seventh gearwheel group for providing seven sequentially increasing forward gear speeds. The gear speed is also known as a gear in short form. Each gear speed has its corresponding gear ratio, which is calculated by dividing an engine revolution speed over an output speed of a specified gear. The sequentially increasing gear speeds describe an escalating order that members of the order follow each other consecutively. Gears of the DCT can be arranged in a sequentially increasing manner from a first gear to a seventh gear. Correspondingly, gear ratios of the DCT decrease from the first gear to the seventh gear. For example, in a car having the DCT of seven gears, a first gear has a gear ratio of 2.97:1. A second gear has a gear ratio of 2.07:1. A third gear has a gear ratio of 1.43:1. A fourth gear has a gear ratio of 1.00:1. A fifth gear has a gear ratio of 0.84:1. A sixth gear has a gear ratio of 0.56:1. Lastly, a seventh gear has a gear ratio of 0.32:1. The seven gears provide an increasing order of output gears for driving a car.

The first gearwheel group comprises a fixed wheel first gear on one of the input shafts. The fixed wheel first gear meshes with an idler first gear on one of the layshafts. A gearwheel on the input shaft is a driving gearwheel because it exerts active driving torque for propelling the gearwheel on the layshaft. Accordingly, the gearwheel on the layshaft is a driven gearwheel because it receives the driving torque from its meshing gearwheel on the input shaft passively. In the same logic, the driven gearwheel becomes a driving gearwheel when it provides further transmits the driving torque to another gearwheel in its downstream. The fixed gearwheel on the input shaft can alternatively be replaced by an idler gearwheel in cooperation with a coupling device. The pinion is mounted on the one layshaft for outputting a first forward gear speed.

The second gearwheel group comprises a fixed wheel second gear on one of the input shafts, meshing with an idler second gear on one of the layshafts that is mounted with the pinion for providing a second forward gear speed. The third gearwheel group comprises a fixed wheel third gear on one of the input shafts, meshing with an idler third gear on one of the layshafts that is installed with the pinion for providing a third forward gear speed. The fourth gearwheel group comprises a fixed wheel fourth gear on the one of the input shafts, meshing with an idler fourth gear on one of the layshafts that is mounted with the pinion for providing a fourth forward gear speed.

The fifth gearwheel group comprises a fixed wheel fifth gear on one of the input shafts, combing with an idler fifth gear on one of the layshafts that is attached with the pinion for providing a fifth forward gear speed. The sixth gearwheel group comprises a fixed wheel sixth gear on one of the input shafts, which combs with an idler sixth gear on one of the layshafts that is placed with the pinion for providing a sixth forward gear speed. The seventh gearwheel group comprises a fixed wheel seventh gear on one of the input shafts, combing with an idler seventh gear on one of the layshafts. The layshaft with the idler seventh gear also holds the pinion for providing a seventh forward gear speed.

One or more coupling device is mounted on one of the layshafts that carry the idler gearwheels. The one or more coupling device selectively engages the idler gears for outputting the seven gear speeds. An output gear speed corresponds to the selected idler gear.

In particular, the pinion comprises a first pinion that is mounted on the first layshaft via a bearing such that the first pinion is free to rotate around the first layshaft as an idler gearwheel. The first pinion provides an option for outputting the driving torque when it is locked to its carrying layshaft. The carrying layshaft is a layshaft that supports the first pinion and holds the first pinion in place.

The DCT provides seven forward gears through a dual clutch which is efficient and compact. Since the DCT utilize the dual clutch, two clutches of the DCT can alternatively engaged for powering the idler gears with negligible gap of propulsion power during gear shifting.

The DCT enables a pre-selection of idler gears for smooth and fast gear shifting during vehicle acceleration or deceleration. In the DCT, only one of the two input shafts is engaged to an engine at a time and two consecutive idler gears are physically separate gearwheels. In the pre-selection, two coupling devices can engage two idler gears of different gear speeds at the same time. As a result, only one of the two idler gears receives engine torque from an input shaft, whilst the other idler gear is pre-selected by engaging its carrying layshaft without receiving the engine torque. The pre-selected idler gear is predicted to provide a next gear speed during the acceleration or deceleration. This approach avoids abrupt engagement of an idler gear that the idler gear is only engaged when its corresponding gear speed is required for output. Hence, the predicted next gear speed can be produced more rapidly because only a shift of input shafts is needed for outputting the pre-selected gear speed. In other words, two idler gears of two consecutive gear speeds can be driven by different input shafts of the DCT in the pre-selection such that the transition between two consecutive gear speeds merely requires alternating between two clutches of the DCT. For example, idler gearwheels of the fourth gear and the fifth gear can be both engaged to their weight-carrying layshaft by their respective coupling devices when only the fourth idler gear receives the engine torque. In this manner, little or no interruption of torque flow occurs during the gearshift. Therefore, the double-clutch transmission can provide continuous and speedy gearshifts.

The DCT can further comprise a first sprocket gearwheel and a second sprocket gearwheel on separate layshafts that are coupled together via a drive chain. The two sprocket gearwheels are installed on separate layshafts for transmitting driving torque in-between. The first sprocket, the chain and the second sprocket form a chain drive that is efficient and reliable for torque transmission. The chain drive also allows a wide range of distance between the two layshafts that carry the two sprockets respectively.

Idler gearwheels of odd forward gear speeds and idler gearwheels of even forward gear speeds can be driven by different input shafts. The odd forward gear speeds include a first gear speed, a third gear speed, a fifth gear speed and a seventh gear speed. The even gear speeds are a second gear speed, a fourth gear speed, a sixth gear speed. Since the different input shafts are connected to these two clutch discs respectively, the DCT can alternatively engage one of the clutch input shafts when the DCT decelerates or accelerates. Momentum of the engine and the DCT is barely lost during these speed variations due to swift engagements between the two clutch discs.

The DCT can have a park-lock gearwheel fixed onto one of the layshafts that carries the pinion, which is a final drive. The final drive pinion combs with an output gearwheel on an output shaft. A differential connects the output gearwheel to wheels of a vehicle such that the vehicle can be held stationary in a secure manner, even on a slope. The park-lock is easy to implement and beneficial for ensuring the vehicle and passengers' safety.

The DCT can also comprise an inner clutch disc non-rotatably connected to the inner input shaft and an outer clutch disc non-rotatably connected to the outer input shaft. For example, the first clutch disc is fixed onto the inner input shaft and the second clutch disc is fixed onto the outer input shaft. Alternatively, a universal joint can provide any of the non-rotatable connections. The inner clutch disc and the outer clutch disc are alternatively known as an inner clutch and an outer clutch respectively, which are the two clutches of the DCT.

Two or more of the idler gears of the seven forward gear speeds share a same physical gearwheel. For instance, the idler first gear also serves as the idler fifth gear so that one physical gearwheel is avoided for providing these two gear speeds. The DCT thus is reduced in weight and cost.

The DCT can comprises a reverse gearwheel group that comprises a driving gearwheel on one of the input shafts, meshing with one or more driven idler gearwheels on the layshafts for providing a reverse gear speed. The reverse gear makes the vehicle with the DCT to be more maneuverable in parking and driving off.

The reverse gear speed can be provided by an input shaft that is different from the input shaft of a low gear speed. The low gear speed can be a first forward gear speed, a second forward gear speed, a third forward gear speed or a fourth forward gear speed. The DCT is capable of engage the two input shafts alternatively so that the vehicle can be rapidly driven back & forth. This scheme is useful for moving the vehicle out of a muddy puddle because the vehicle can simply be driven back & forth to get out the puddle by the alternating engagements. Less loss of momentum of the gearwheels can be achieved. For example, the back and forth movements can be provided by the second forward gear speed and a first reverse gear speed of different input shafts. Alternatively, the first forward gear speed and a second reverse gear speed of different input shafts can achieve the same driving scheme.

Two or more idler gearwheels of the seven forward gear speeds can be mounted on a same layshaft. More gearwheels on one layshaft alleviate the need of providing separate layshafts for carrying multiple idler gearwheels. Less number of layshafts that hold these idler gearwheels enables the DCT to be made simpler and lighter.

These idler gearwheels of seven forward gear speeds can be mounted on the same layshaft. Hence, no additional layshaft is required for providing these seven forward gear speeds, which is beneficial for reducing weight and cost of the DCT.

The DCT can comprise an eighth gearwheel group that comprises a fixed wheel eighth gear on one of the input shafts, meshing with an idler eighth gear on one of the layshafts with the pinion for providing an eighth forward gear speed. The eighth gearwheel group provides an additional forward gear speed to the DCT that further enhance the performance of the DCT.

The DCT can comprise bearings for supporting these layshafts and the output shaft. One or more of the bearings are provided next to the pinion or the output gearwheel. The bearings prevent excessive shaft bending due to gear meshing among these gearwheels such that meshing gearwheels can comb with more desired accuracy for less noise and improved efficiency.

The DCT can comprise three pinions that are mounted onto the three layshafts respectively. These three pinions mesh with the output gearwheel respectively for outputting a drive torque to a torque drain. The output gearwheel can be integrated into a transmission differential device without providing an intermediate output shaft of the differential. This allows a very dense packaging situation for the DCT.

The DCT can comprise a clutch housing that has a larger diameter around the inner clutch disc than that around the outer clutch disc. The clutch housing enables a more robust construction of the DCT. The DCT may also have two reverse gear speeds, which enables a specialized vehicle to be more maneuverable.

The application can provide a power train device with the double-clutch transmission device. The power train device can comprise one or more power source, such as an internal combustion engine, an electric motor, and a hybrid engine for generating a driving torque. The power train device usually has the DCT and the power source onboard so that a vehicle with the power train device can be mobile without being physically attached to an external stationary power source. The internal combustion engine can use other fuels with less emission, such as biofuel and hydrogen fuel for better environmental protection. The electric motor can even recuperate brake energy of the vehicle in a generator mode.

The application can have a vehicle that comprises the power train and a differential. The differential is coupled to the output shaft. The vehicle having the power train device is efficient in energy usage and in superior performance by using the DCT.

### BRIEF DESCRIPTION OF THE DRAWINGS

The present invention will hereinafter be described in conjunction with the following drawing figures, wherein like numerals denote like elements, and

FIG. 1 illustrates a front view of an embodiment of a double clutch transmission of the present application;

FIG. 2 illustrates an expanded cross-section view of the double clutch transmission with the torque flow path of a first gear speed;

FIG. 3 illustrates the torque flow path of a second gear speed;

FIG. 4 illustrates the torque flow path of a third gear speed;

FIG. 5 illustrates the torque flow path of a fourth gear speed;

FIG. 6 illustrates the torque flow path of a fifth gear speed;

FIG. 7 illustrates the torque path flow of a sixth gear speed;

FIG. 8 illustrates the torque flow path of a seventh gear speed;

FIG. 9 illustrates the torque flow path of an eighth gear speed;

FIG. 10 illustrates the torque flow path of a reverse gear speed;

FIG. 11 illustrates an assembly of a double-sided coupling device with its neighboring idler gears for engagement;

FIG. 12 illustrates an assembly of a single-sided coupling device with its neighboring idler gear for engagement;

FIG. 13 illustrates an assembly of an idler gear that is rotatably supported by a shaft;

FIG. 14 illustrates an assembly of a fixed gearwheel that is supported on a shaft;

FIG. 15 illustrates a cross-section through a detail of a crankshaft of an internal combustion engine according to the embodiment;

FIG. 16 illustrates a front view of a second embodiment of a double clutch transmission of the present application; and

FIG. 17 illustrates an expanded cross-section view of the second embodiment of the double clutch transmission.

### DETAILED DESCRIPTION

The following detailed description is merely exemplary in nature and is not intended to limit application and uses. Furthermore, there is no intention to be bound by any theory presented in the preceding background or summary or the following detailed description. Moreover, in the following description, details are provided to describe embodiments of the application. It shall be apparent to one skilled in the art, however, that the embodiments may be practiced without such details.

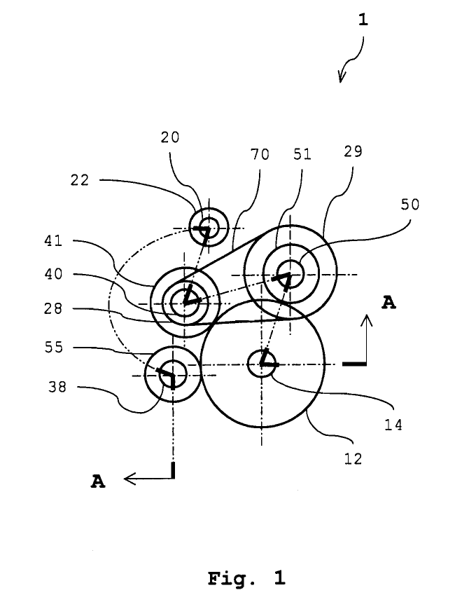

FIGS. 1-15 facilitate detailed description of a first embodiment of a double clutch transmission (DCT) 1 of the present application. FIGS. 1-15 comprise parts that have same reference numbers. Relevant description of these parts is incorporated where necessary.

FIG. 1 illustrates a front view of the DCT 1. The DCT 1 comprises two input shafts 20, 22, a lower layshaft 50, an upper layshaft 40, a reverse gear layshaft 38, and an output shaft 14. These shafts are parallel to each other.

The two input shafts 20, 22 comprise an inner input shaft 20 and an outer input shaft 22. The inner input shaft 20 is a solid input shaft 20, whilst the outer input shaft 22 is a hollow input shaft 22. The solid input shaft 20 is partially disposed inside the hollow outer input 22 on the right. The solid input shaft 20 and the hollow input shaft 22 share the same longitudinal axis of rotation.

An upper pinion 51, a lower pinion 41 and a reverse pinion 55 are fixed to right ends of the upper layshaft 40, the lower layshaft 50 and the reverse gear layshaft 38 respectively. An output gearwheel 12 is fixed in the middle of the output shaft 14. These three pinions 41, 51, 55 mesh with the output gearwheel 12 separately at different positions of the output gearwheel 12.

A first sprocket 28 is mounted onto the upper layshaft 40 whilst a second sprocket 29 is mounted onto the lower layshaft 50. The two sprockets 28, 29 are connected together via a chain 70.

There are other gearwheels mounted onto these shafts such that some of these gearwheels mesh with each other according to predetermined manners. These manners are better seen in some of the following figures.

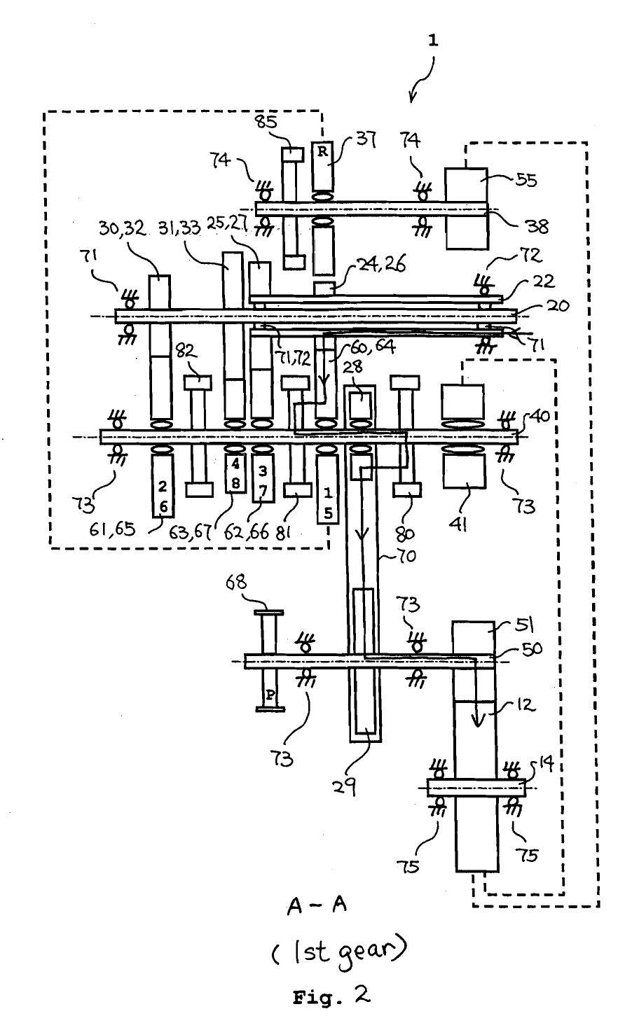

FIG. 1 further shows a cutting plane A-A that passes centers of these shafts for illustrating an expanded cross-section view of the DCT 1. The expanded view is shown in FIGS. 2 to 15. The cutting plane A-A passes through the longitudinal axes of the output shaft 14, the lower layshaft 50, the upper layshaft 40, the solid input shaft 20, and the reverse gear layshaft 38 consecutively. One of the goals of FIGS. 2 to 15 is to illustrate further structure and torque flows of the DCT 1.

FIG. 2 illustrates an expanded cross-section view A-A of the DCT 1 with the torque flow path of a first gear speed. According to FIG. 2, the DCT 1 comprises following shafts, from top to bottom, the reverse gear layshaft 38, the hollow input shaft 22, the solid input shaft 20, the upper layshaft 40, the lower layshaft 50, and the output shaft 14. The solid input shaft 20 is partially disposed inside the hollow input shaft 22 such that the hollow input shaft 22 surrounds the solid input shaft 20 radially around its longitudinal axis. The solid input shaft 20 also protrudes outside the hollow input shaft 22 at two opposite ends. The hollow input shaft 22 is mounted onto the solid input shaft 20 by a pair of solid shaft bearings 71 that are disposed between the solid input shaft 20 and the hollow input shaft 22 at two ends of the hollow input shaft 22. The solid shaft bearing 71 on the left also serves as a hollow shaft bearing 72. As a result, the two input shafts 20, 22 are coupled together such that the solid input shaft 20 is free to rotate inside the hollow input shaft 22. A left portion of the solid input shaft 20 is exposed outside the hollow input shaft 22. The assembly of the input shafts 20, 22 is supported by the solid shaft bearing 71 at a protruding end of the solid shaft 20 on the left and by the hollow shaft bearing 72 on the hollow input shaft 22 on the right.

There are two gearwheels fixed on the left exposed portion of the solid input shaft 20. These gearwheels are a fixed wheel second gear 30 and a fixed wheel fourth gear 31 from left to right sequentially. The fixed wheel second gear 30 also serves as a fixed wheel sixth gear 32, whilst the fixed wheel fourth gear 31 further serves as a fixed wheel eighth gear 33. Both of the fixed wheel second gear 30 and the fixed wheel fourth gear 31 are joined to the solid input shaft 20 coaxially. The hollow input shaft 22, which is mounted on the right portion of the solid input shaft 20, has a fixed wheel third gear 25 and a fixed wheel first gear 24 from left to right successively. The fixed wheel third gear 25 also serves as a fixed wheel seventh gear 27. The fixed wheel first gear 24 further functions as a fixed wheel fifth gear 26. The fixed wheel third gear 25 and the fixed wheel first gear 24 are placed onto the hollow input shaft 22 coaxially.

The upper layshaft 40 is shown to be below the input shafts 20, 22. There are gearwheels, coupling devices and bearings provided on the upper layshaft 40. These include, from left to right, a layshaft bearing 73, a idler second gear 61, a double-sided coupling device 82, a idler fourth gear 63, a idler third gear 62, a double-sided coupling device 81, a idler first gear 60, a first sprocket 28, a double-sided coupling device 80, the upper pinion 41 and a layshaft bearing 73. The idler second gear 61, the idler fourth gear 63, the idler third gear 62, the idler first gear 60, the first sprocket 28, and the upper pinion 41 are mounted onto the upper layshaft 40 coaxially via bearings respectively such that they are free to rotate around the upper layshaft 40 as idlers. The idler second gear 61 also serves as an idler sixth gear 65. The idler fourth gear 63 also functions as an idler eighth gear 67. The idler third gear 62 further performs as an idler seventh gear 66. The idler first gear 60 also works as an idler fifth gear 64.

Each of these double-sided coupling devices 80, 81, 82 can move along the upper layshaft 40 for engaging its neighboring gearwheels to the upper layshaft 40. The idler second gear 61 meshes with the fixed wheel second gear 30. The idler fourth gear 63 combs with the fixed wheel fourth gear 31. The idler third gear 62 meshes with the fixed wheel third gear 25. The idler first gear 60 combs with the fixed wheel first gear 24.

The lower layshaft 50 is further provided below the upper layshaft 40. A plurality of components is mounted on the lower layshaft 50. These components include gearwheels and bearings. These components comprise, from left to right, a fixed park-lock gearwheel 68, a layshaft bearing 73, a second sprocket 29, a layshaft bearing 73 and the lower pinion 51. All of the fixed park-lock gearwheel 68, the second sprocket 29 and the lower pinion 51 are immovably joined to the lower layshaft 50 coaxially. The second sprocket 29 has a larger diameter than that of the first sprocket 28 such that the second sprocket 29 has more number of teeth or gears than that of the first sprocket 28. The second sprocket 29 meshes with the first sprocket 28 via the chain 70 such that they form a chain drive.

The output shaft 14 is further provided further below the lower layshaft 50. Two output shaft bearings 75 are installed at two opposite ends of the output shaft 14 respectively for supporting. The output gearwheel 12 is fixed onto the output shaft 14 coaxially in its central position. The output shaft 14 is coupled to a differential such that input torque from an engine is transmitted to wheels of the car via the DCT 1.

The reverse gear layshaft 38 is provided above the input shafts 20, 22. A reverse layshaft bearing 74, a single-sided coupling device 85, a reverse gear idler wheel 37, a reverse layshaft bearing 74 and the reverse pinion 55 are mounted onto the reverse gear layshaft 38 from left to right. The reverse gear idler wheel 37 is mounted onto the reverse gear layshaft 38 coaxially via a bearing such that the reverse gear idler wheel 37 can rotate freely around the reverse gear layshaft 38. In contrast, the reverse pinion 55 is fixed onto the reverse gear layshaft 38 such that they are united together as one integral part. The single-sided coupling device 85 can move along the reverse gear layshaft 38 to engage or disengage the reverse gear idler wheel 37 to the reverse gear layshaft 38. The reverse gear idler wheel 37 combs with the idler first gear 60.

The fixed park-lock gearwheel 68 resides on the lower layshaft 50 that bears a final drive pinion 51. The fixed park-lock gearwheel 68 comprises a ratchet gearwheel that cooperates with a pawl for locking rotary movement of the lower pinion 51. The fixed park-lock gearwheel 68 provides a park-lock function to the DCT 1 that stops a vehicle from moving when parked. Detailed structure of the park-lock is omitted in FIG. 2.

The DCT 1 with the park-lock is controlled by a gearshift lever located in a driving compartment and movable by a vehicle operator between positions corresponding to transmission gear ranges such as Park, Reverse, Neutral, Drive, and Low positions. When the gearshift lever is placed in the Park position, two related mechanical actuations take place within the DCT 1. Firstly, a mode select lever is moved to disengage the input shafts 20, 22 from an engine. Secondly, the pawl is moved into locking engagement with the fixed park-lock gearwheel 68 on the lower layshaft 50 to lock the output shaft 14 against rotation. A linear actuation cable that actuates the mode select lever moves the pawl.

In the present specification, the expressions “mesh” and “comb” with respect to geared wheels or engaged gearwheels are provided as synonyms. In a generic sense, a hollow shaft that is disposed inside the hollow input shaft 22 can replace the solid input shaft 20. The term “coupling device” is alternatively termed as “shifting mechanism” or “synchronizer” for engaging or disengaging gearwheels on its carrying shaft. The double-clutch transmission (DCT) is alternatively termed as a double clutch gearbox, or a dual clutch transmission (DCT).

Gearwheels on the input shafts 20, 22 are known as driving gearwheels because they receive driving torque from the engine directly. The driving gearwheels include the fixed wheel first gear 24, the fixed wheel third gear 25, the fixed wheel second gear 30, and the fixed wheel fourth gear 31. In this respect, gearwheels on other shafts 14, 38, 40, 50 are driven gearwheels because they receive the driving torque from the gearwheels on the input shafts 20, 22. Driven gearwheels include the output gear wheel 12, the first sprocket 28, the second sprocket 29, the reverse gear idler wheel 37, the upper pinion 41, the lower pinion 51, the reverse pinion 55, the idler first gear 60, the idler second gear 61, the idler third gear 62, the idler fourth gear 63, and the fixed park-lock gearwheel 68.

The upper pinion 41, the lower pinion 51, and the reverse pinion 55 are alternatively known called final drive pinions or final drives. Any fixed gearwheel on a layshaft that has a final drive pinion can serve as a park-lock gearwheel when cooperating with a pawl. The pawl is a spring-loaded pivoting finger. Any of the input shafts 20, 22 or layshafts 38, 40, 50 can be supported by more than two bearings for reducing shaft bending when experiencing gear meshing pressure.

The chain 70 is also known as a roller chain, a bush roller chain, or a steel transmission roller chain. The chain 70 may include a simplex chain, a duplex chain, and a triplex chain. The chain 70 may also include an inverted tooth drive chain or a timing chain for meshing with corresponding sprockets.

In these figures (Figs.) of the present application, a dash line indicates combing relationship between gearwheels.

The application provides the DCT 1 that permits less loss of driving torque. The DCT 1 provides separate clutch discs 8, 10 that are connected to different input shafts 20, 22 for driving odd and even gear speeds separately. One of the clutches drives idlers of odd numbered gear speeds, while the other clutch drives idlers of the even numbered gear speeds. Engine torque is always applied to one of the input shafts 20, 22 when an engine is running, which causes negligible interruption to torque transmission.

The DCT enables speedy and smooth gearshift operations when shifting gear speeds. Since a coupling device can engage one intended idler of a gear speed even when a driving gearwheel of the intended idler has not yet received the engine torque, the idler can receive the engine torque immediately when an input shaft of the driving gearwheel engages the engine. This provides the convenience of pre-selecting a gear speed even when the gear speed is not currently in use. An on-board computer connected to the DCT 1 can intelligently pre-select a gear speed for fuel-efficient street driving, which makes an automatic transmission with little interruption in propulsion power. The propulsion power comprises momentum derived from the rotating gearwheels and the shafts of the DCT 1. Such a transmission is similar in design to a mechanical manual transmission and it has correspondingly very low friction losses. The DCT 1 further provides a parallel manual transmission that can be used for transverse installation in a front-wheel drive vehicle.

It is further not only of advantage to provide the even gearwheels fixed onto one input shaft, but also fix the odd gears onto another input shaft. This arrangement provides the above-mentioned gear speed pre-selection operation in a smooth and efficient manner when gear speeds increase or decrease sequentially. This is because the DCT 1 can alternatively engage one of the two clutch discs 8, 10 in the process of accelerating or decelerating. For example, a gearshift operation from the third gear speed to the fourth gear speed causes the hollow input shaft 22 and the solid input shaft 20 being engaged consecutively, which is energy efficient and fast.

The DCT 1 according to the application can be connected similar to a known manual transmission, such as a parallel manual transmission. In the known manual transmission, a drive shaft for the front axle of a vehicle extends outward from its DCT case, and parallel to the output shaft 14 of the main DCT 1. The arrangement of the known manual transmission lefts little space for actuation of the manual transmission and clutch, and for an optional electric motor. The optional electric motor can act as a starter device for a combustion engine, as an energy recuperation device for brake operation, or as an additional drive means in hybrid vehicles. Having such little space presents difficulties that are solved or that at least alleviated by the DCT 1. The DCT 1 that has two clutches for connecting to an electrical motor and the manual transmission respectively in a compact manner.

The application provides a compact structure of a parallel transmission. The parallel transmission includes two input shafts 20, 22, each of which can be non-rotatably coupled to a shaft via its own clutch that is powered by a drive engine of a vehicle. The DCT 1 further provides the output shaft 14 that is parallel to the input shafts 20, 22.

The DCT 1 is particularly well suited for transverse installation in front-wheel drive vehicles, in which the front differential, for example, is positioned below the pinions 41, 51. A short overall length of the power train for transmitting torques can be achieved.

The DCT 1 provides three relatively small pinions 38, 41, 51 that comb with one relatively big output gearwheel 12. The output gearwheel 12 in turn is fixed onto the output shaft 14. This arrangement provides a compact and lightweight DCT 1 by avoiding having multiple output gearwheels.

The DCT 1 further enables a design in which the output gearwheel 12 is integrated into a transmission differential device without providing the intermediate output shaft 14 of the DCT 1. This allows a very dense packaging situation for the DCT 1.

The DCT 1 provides idler gearwheels of eight speeds on the same upper layshaft 50. Moreover, each of these physical idler gearwheels is shared by two gear speeds such that the number of physical idler gearwheels is only half of the number of gear speeds. This is an arrangement of group transmission that has greatly reduced the number of physical gearwheels and layshafts, which is beneficial for size, cost and weight reduction of the DCT 1.

These layshaft bearings 73, 74 of the DCT 1 are mounted immediately next to the pinions 41, 51, 55. The layshaft bearings 73, 74 offer strong support to the weight-carrying layshafts 38, 40, 50 for reducing unwanted shaft deflection. Excessive shaft bending can lower gear transmission efficiency or cause gearwheels' early worn out. In a like manner, the output shaft bearings 75 at two opposite ends of the output shaft 14 offer sturdy support to the output shaft 14.

The DCT 1 employs the chain 70 for torque transmission between the upper layshaft 40 and the lower layshaft 50. The chain drive formed by the chain 70, the first sprocket 28, and the second sprocket 29 is simple, reliable, and efficient for torque transmission between the upper layshaft 40 and the lower layshaft 50.

The chain 70 is a steel transmission roller chain that is made to close tolerances with excellent joint articulation, permitting smooth efficient flow of power. Any friction between chain rollers and sprocket teeth of the chain drive is almost eliminated because rollers of the chain 70 rotate on outside surfaces of bushes, independent of bearing pin articulation inside the bush. As a result, very little transmission power is wasted. Tests have shown the chain 70 that can have a transmission efficiency of between 98.4% and 98.9%. Only gears of the highest standard can equal this high level of efficiency, which is achieved by the chain drive under the correct conditions of lubrication and installation, with teeth grounded to very close tolerances.

The chain 70 offers a positive, non-slip driving medium. The chain 70 provides an accurate pitch-by-pitch positive drive, which may be essential on synchronized drives to automobiles. Under conditions of high speed and peak load when efficiency is also required, the chain 70 has proved to be consistently quiet and reliable.

Centre distances between the sprocket carrying layshafts 40, 50 can range from 50 mm up to more than 9 m in a very wide range installation envelope. Drives can be engineered so that sprocket teeth just clear each other that the chain 70 traverses a considerable span.

The chain 70 having a certain degree of inherent elasticity and this, plus the cushioning effect of an oil film in the chain joints, provide good shock absorbing properties. In addition, the load distribution between the chain 70 and the sprockets 28, 29 takes place over a number of teeth, which assists in reducing wear. When, after lengthy service, it becomes necessary to replace the chain 70, this is simple and does not normally entail the sprockets 28, 29 or bearings 73 removals.

The chain 70 minimizes loads on the engine and layshaft bearings 73 since no preload is required to tension the chain 70 in the static condition.

The chain 70 can drive several shafts simultaneously and in variety of configurations of centre distance or layout. Its adaptability is not limited to driving one or more shafts from a common drive point. The chain 70 can be used for a large variety of devices including reciprocation, racks, cam motions, internal or external gearing, counterbalancing, hoisting, or weight suspension. Segmental tooth or “necklace” chain sprocket rims can be fitted to large diameter drums.

Since there are no elastomeric components involved, the chain 70 is tolerant of a wide variety of environmental conditions, including extremes of temperature. The chain 70 has been used successfully in such harsh environments as chemical processing, mining, baking, rock drilling and wood processing. Special coatings can easily be applied for further enhancement.

The single roller chain drive is suitable for ratios up to 9:1 and to transmit up to 520 kW at 550 rev/min. Beyond this, four matched strands of triplex chain can achieve 3200 kW at 300 rev/min.

The chain 70 has little deterioration with the passage of time. Known evidence of aging in the form of elongation due to wear is typically gradual. The aging can be accommodated by centre distance adjustment or by an adjustable jockey sprocket. Provided the chain drive is selected correctly, properly installed and maintained, a life of 15,000 h can be expected without chain failure either from fatigue or wear.

The chain 70 is highly standardized product available in accordance with ISO standards all over the world. It is also completely recyclable and causes no harmful effects to the environment.

FIG. 2 also illustrates the torque flow path of a first gear speed. According to FIG. 2, the torque of the first gear speed is transmitted from the hollow input shaft 22, via the fixed wheel first gear 24, via the idler first gear 60, via the double-sided coupling device 81, via the upper layshaft 40, via the double-sided coupling device 80, via the first sprocket 28, via the chain 70, via the second sprocket 29, via the lower layshaft 50, via the lower pinion 51, via the output gear wheel 12, to the output shaft 14. The double-sided coupling device 81 engages the idler first gear 60 to the upper layshaft 40 when transmitting the torque of the first gear speed. In the mean time, the double-sided coupling device 80 engages the first sprocket 28 to the upper layshaft 40. The number of tooth engagements or engaged gear pairs for the torque transfer of the first gear speed is four.

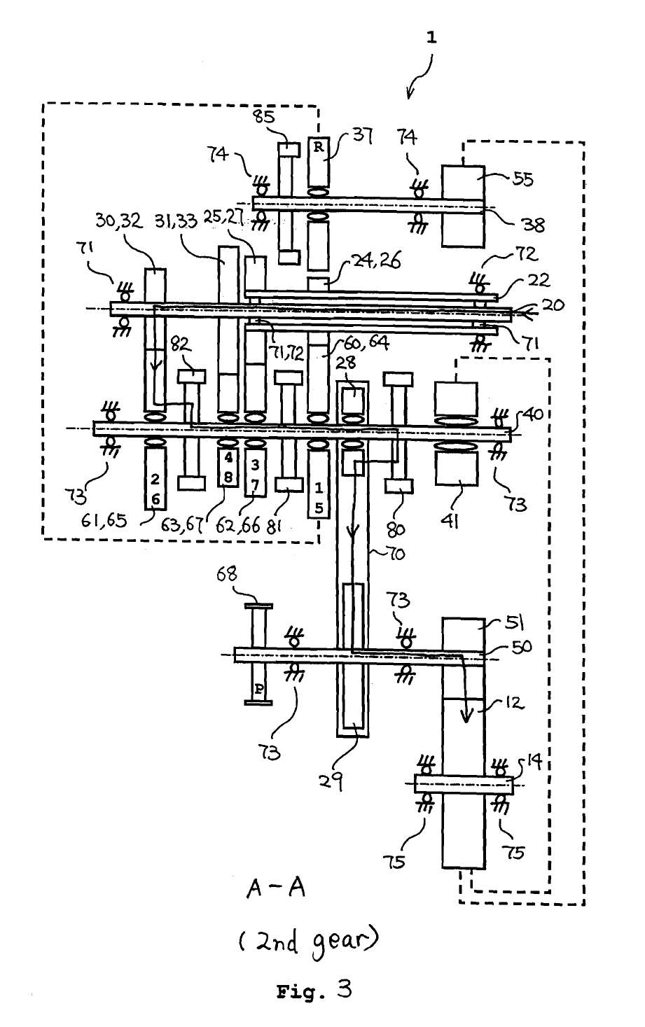

FIG. 3 illustrates the torque flow path of a second gear transmission speed. In FIG. 3, an torque of the second gear speed is transmitted from the solid input shaft 20, via the fixed wheel second gear 30, via the idler second gear 61, via the double-sided coupling device 82, via the upper layshaft 40, via the double-sided coupling device 80, via the first sprocket 28, via the chain 70, via the second sprocket 29, via the lower layshaft 50, via the lower pinion 51, via the output gear wheel 12, to the output shaft 14. The double-sided coupling device 82 engages the 61 to the upper layshaft 40 when transmitting the torque of the second gear, which provides the second gear speed of the DCT 1. Simultaneously, the double-sided coupling device 80 engages the first sprocket 28 to the upper layshaft 40. The number of tooth engagements or engaged gear pairs for the torque transfer of the second gear speed is four.

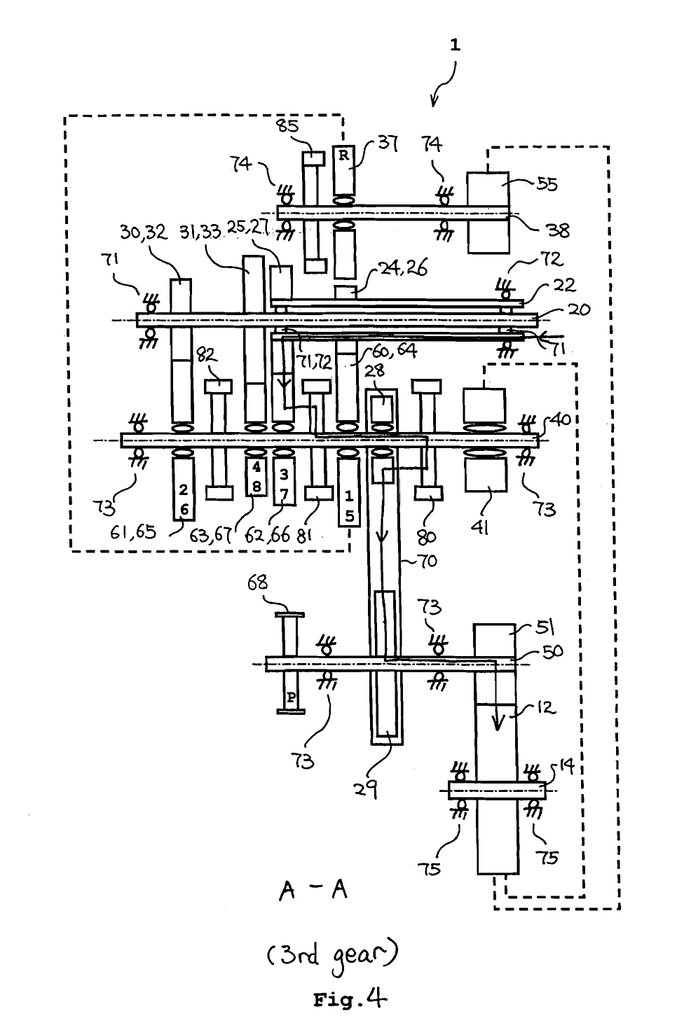

FIG. 4 illustrates the torque flow path of a third gear transmission speed. In FIG. 4, a torque of the third gear speed is transmitted from the hollow input shaft 22, via the fixed wheel third gear 25, via the idler third gear 62, via the double-sided coupling device 81, via the upper layshaft 40, via the double-sided coupling device 80, via the first sprocket 28, via the chain 70, via the second sprocket 29, via the lower layshaft 50, via the lower pinion 51, via the output gear wheel 12, to the output shaft 14. The double-sided coupling device 81 engages the idler third gear 62 to the upper layshaft 50 when transmitting the torque of the third gear speed. Concurrently, the double-sided coupling device 80 engages the first sprocket 28 to the upper layshaft 40. The number of tooth engagements or engaged gear pairs for the torque transfer of the third gear speed is four.

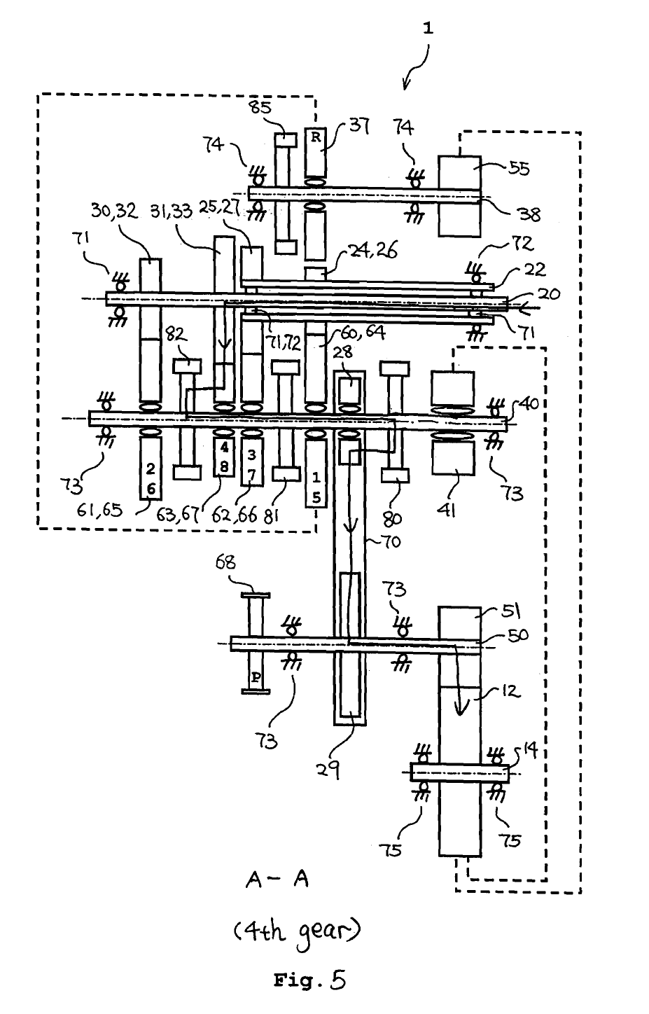

FIG. 5 illustrates the torque flow path of a fourth gear transmission speed. In FIG. 5, the torque of the fourth gear speed is transmitted from the solid input shaft 20, via fixed wheel fourth gear 31, via the idler fourth gear 63, via the double-sided coupling device 82, via the upper layshaft 40, via the double-sided coupling device 80, via the first sprocket 28, via the chain 70, via the second sprocket 29, via the lower layshaft 50, via the lower pinion 51, via the output gear wheel 12, to the output shaft 14. The double-sided coupling device 82 engages the idler fourth gear 63 to the upper layshaft 40 when transmitting the torque of the fourth gear speed. Concurrently, the double-sided coupling device 80 locks the first sprocket 28 to the upper layshaft 40. The number of tooth engagements or engaged gear pairs for the torque transfer of the fourth gear speed is four.

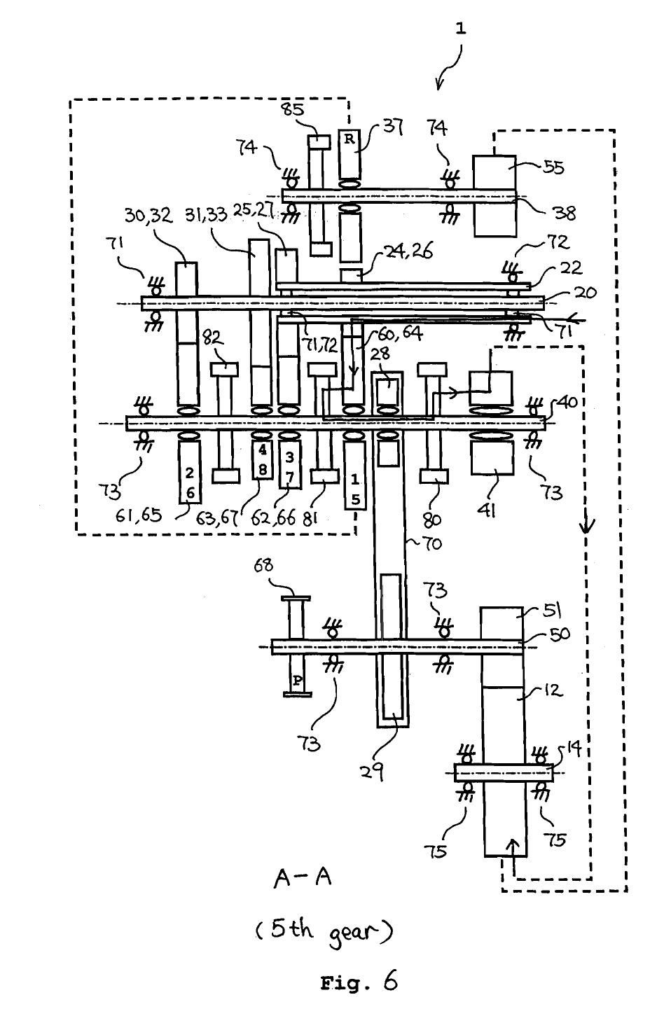

FIG. 6 illustrates the torque flow path of a fifth gear transmission speed. In FIG. 6, the torque of the fifth gear speed is transmitted from the hollow input shaft 22, via the fixed wheel fifth gear 26, via the idler fifth gear 64, via the double-sided coupling device 81, via the upper layshaft 40, via the double-sided coupling device 80, via the upper pinion 41, via the output gear wheel 12, to the output shaft 14. The double-sided coupling device 81 engages the idler fifth gear 64 to the upper layshaft 40 when transmitting the torque of the fifth gear speed. At the same time, the double-sided coupling device 80 couples the upper layshaft 40 to the upper pinion 41. The number of tooth engagements or engaged gear pairs for the torque transfer of the fifth gear speed is two.

FIG. 7 illustrates the torque flow path of a sixth gear transmission speed. In FIG. 7, the torque of the sixth gear speed is transmitted from the solid input shaft 20, via the fixed wheel sixth gear 32, via the idler sixth gear 65, via the double-sided coupling device 82, via the upper layshaft 40, via the double-sided coupling device 80, via the upper pinion 41, via the output gear wheel 12, to the output shaft 14. The double-sided coupling device 82 joins the idler sixth gear 65 to the upper layshaft 40 when transmitting the torque of the sixth gear speed. Alongside, the double-sided coupling device 80 connects the upper pinion 41 to the upper layshaft 40. The number of tooth engagements or engaged gear pairs for the torque transfer of the sixth gear speed is two.

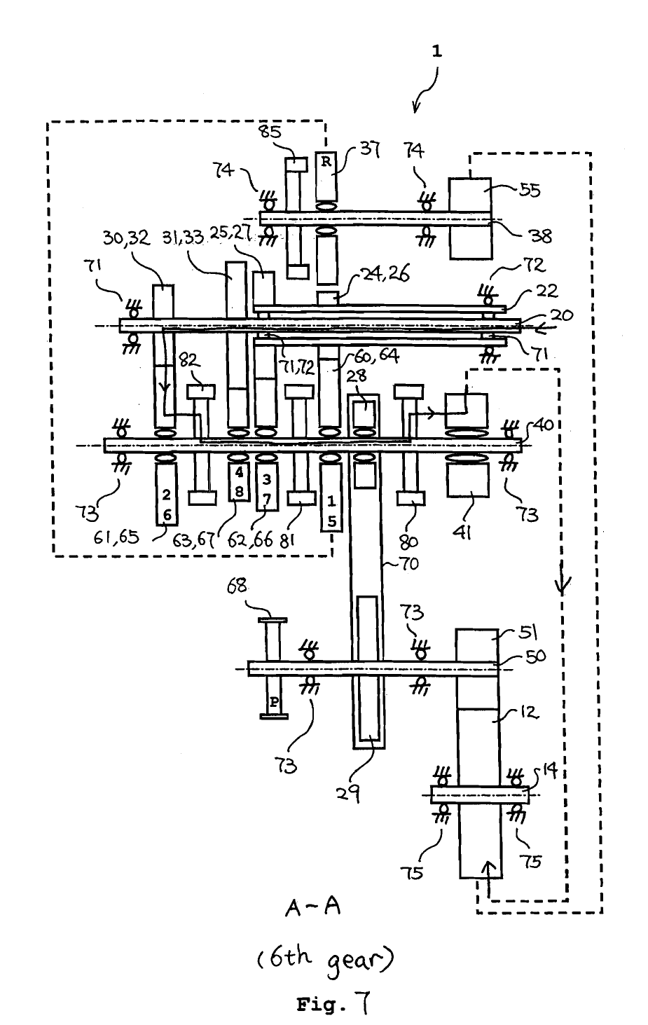

FIG. 8 illustrates the torque flow path of a seventh gear transmission speed. According to FIG. 8, the torque of the seventh gear speed is transmitted from the hollow input shaft 22, via the fixed wheel seventh gear 27, via the idler seventh gear 66, via the double-sided coupling device 81, via the upper layshaft 40, via the double-sided coupling device 80, via the upper pinion 41, via the output gear wheel 12, to the output shaft 14. The double-sided coupling device 82 holds the idler seventh gear 66 and the upper layshaft 40 together when transmitting the torque of the seventh gear speed. At the same moment, the double-sided coupling device 80 bolts the upper pinion 41 to the upper layshaft 40. The number of tooth engagements or engaged gear pairs for the torque transfer of the seventh gear speed is two.

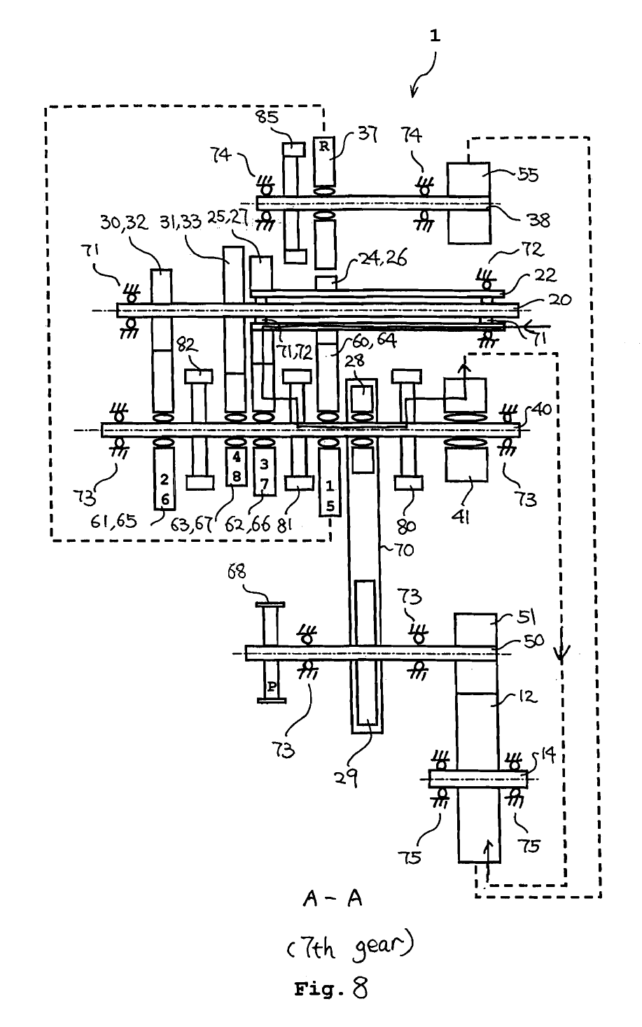

FIG. 9 illustrates the torque flow path of an eighth gear speed. According to FIG. 9, the eighth torque is transmitted from the solid input shaft 20, via the fixed wheel eighth gear 33, via the idler eighth gear 67, via the double-sided coupling device 82, via the upper layshaft 40, via the double-sided coupling device 80, via the upper pinion 41, via the output gear wheel 12, to the output shaft 14. The double-sided coupling device 82 locks the idler eighth gear 67 to the upper layshaft 40 when transmitting the eighth gear speed. Besides, the double-sided coupling device 80 clamps the upper pinion 41 and the upper layshaft 40 together. The number of tooth engagements or engaged gear pairs for the torque transfer of the eighth gear speed is two.

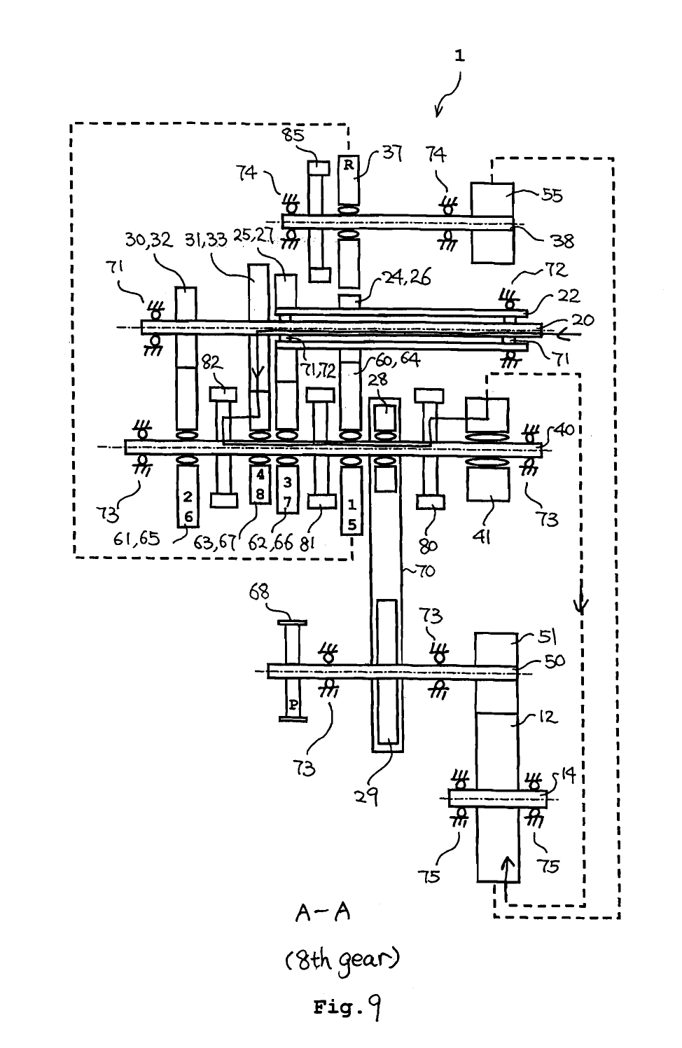

FIG. 10 illustrates the torque flow path of a reverse gear speed. According to FIG. 9, the torque of the reverse gear is transmitted from the hollow input shaft 22, via the idler first gear 60, via the reverse gear idler wheel 37, via the single-sided coupling device 85, via the reverse gear layshaft 38, via the reverse pinion 55, via the output gear wheel 12, to the output shaft 14. When transmitting the reverse gear, the single-sided coupling device 85 locks the reverse gear idler wheel 37 to the reverse gear layshaft 38. The number of tooth engagements or engaged gear pairs for the reverse gear speed is three.

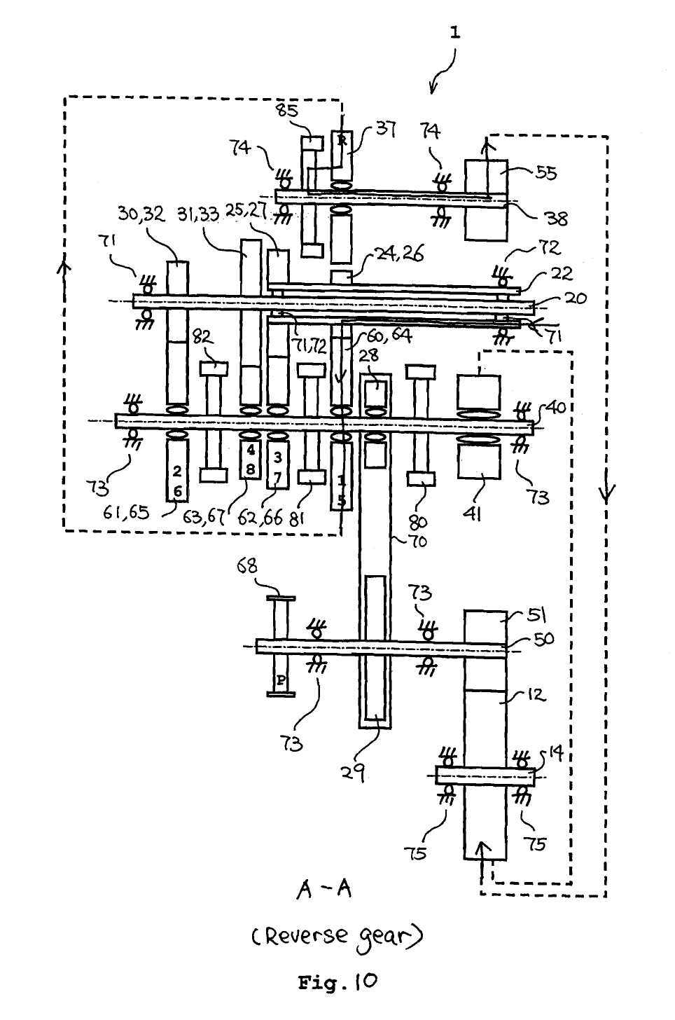

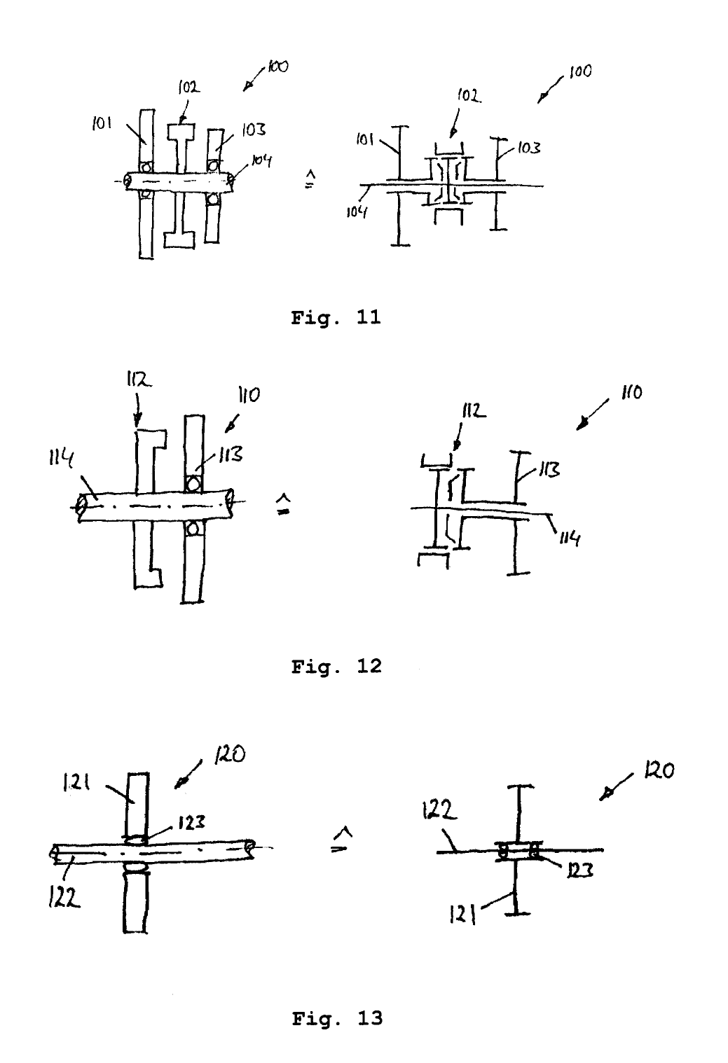

FIG. 11 illustrates an assembly 100 of a double-sided coupling device 102 with its neighboring gearwheels 101, 103 for engagement. The assembly 100 comprises a shaft 104 with the two coaxially mounted idler gear 101, 103 on two bearings respectively. The double-sided coupling device 102 is provided between the idler gear 101 on the left and the idler gear 103 on the right. The coupling device 102 is configured to move along the shaft 104 to selectively engage any of the idler gears 101, 103 at one time. In other words, the idler gears 101, 103 can alternatively be brought into non-rotating engagement with the shaft 104 by the coupling device 102. Symbols for showing the assembly 100 is provided at the right hand side of FIG. 11.

FIG. 12 illustrates an assembly 110 of a single-sided coupling device 112 with its neighboring gearwheel 113 for engagement. The assembly 110 comprises a shaft 114 with the one coaxially mounted idler gear 113 on a bearing. The single-sided coupling device 112 is provided next to the idler gear 113 on the left side. The single-sided coupling device 112 is configured to move along the shaft 114 to engage or disengage the idler gears 113. In other words, the idler gear 113 can be brought into non-rotating engagement with the shaft 114 by the single-sided coupling device 112 when required. Symbols for showing the assembly 110 are provided at the right hand side of FIG. 12.

FIG. 13 illustrates an assembly 120 of an idler gearwheel 121 that is rotatably supported by a shaft 122 on a bearing 123. The idler gearwheel 121 is coaxially mounted onto the shaft 122 via the bearing 123. The bearing 123 enables the idler gearwheel 121 to be freely rotated around the shaft 122. Symbols that represent the assembly 120 are provided at the right hand side of the FIG. 13.

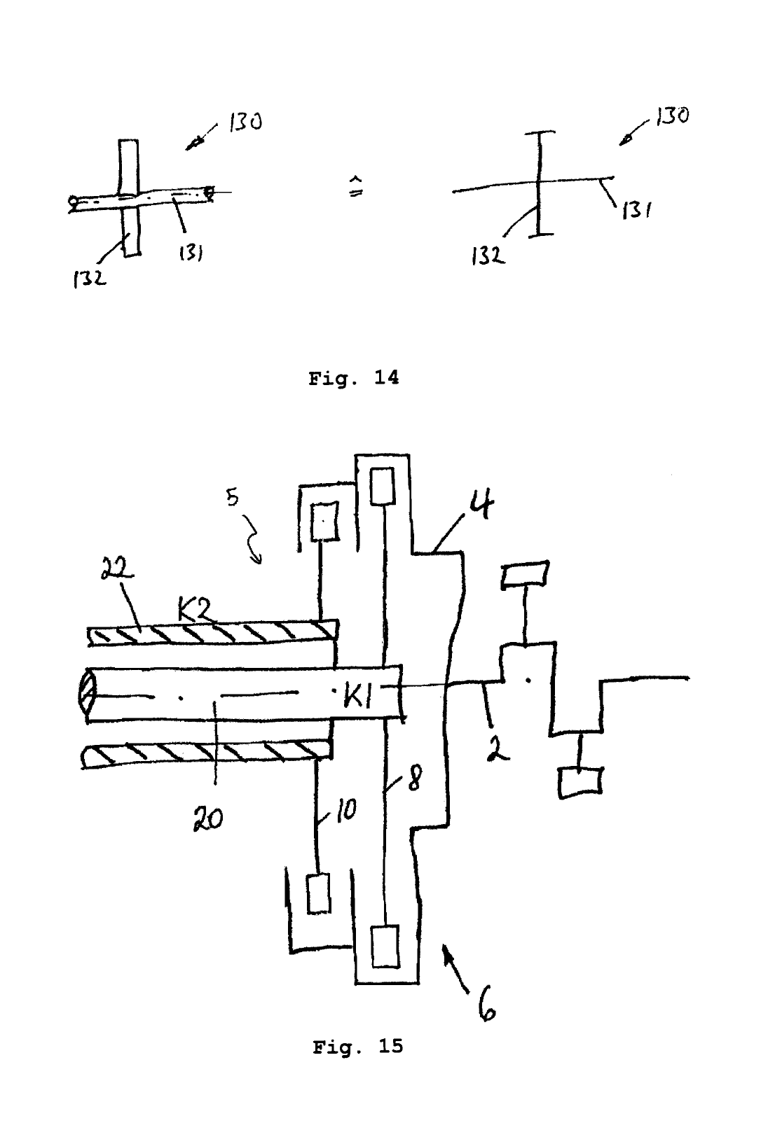

FIG. 14 illustrates an assembly 130 of a fixed gearwheel 132 that is supported on a shaft 131. The fixed gearwheel 132 is coaxially mounted onto the shaft 131 such that the gearwheel 132 is fixed to the shaft 131. The fixed gearwheel 132 and the shaft 131 are joined as one single body such that torque of the fixed gearwheel 132 is transmitted to the shaft 131 directly, and vice versa.

A number of fixed gearwheels are rigidly connected to the input shafts 20, 22 and other shafts 14, 38, 40, 50 in a manner that is similar to the assembly 130. A symbol as used in the previous figures for such a fixed gearwheel is provided on the left side in FIG. 14. The more commonly used symbol for such a fixed gearwheel is provided on the right side in FIG. 14.

FIG. 15 illustrates a cross-section through a detail of a crankshaft 2 of an internal combustion engine (not shown) according to the embodiment of the DCT 1. According to FIG. 15, the crankshaft 2 is non-rotatably connected to a housing 4 of a double clutch 6. The double clutch 6 includes an inner clutch disc 8 and an outer clutch disc 10, which can be brought into non-rotating engagement with the housing 4 via control elements that are not illustrated here. The solid input shaft 20 is non-rotatably connected to the inner clutch disc 8, and extends all the way through the hollow shaft 22. Similarly, the hollow input shaft 22 is non-rotatably connected to the outer clutch disc 10. The inner clutch disc 8 is also known as the inner clutch, whilst the outer clutch disc 10 is also known as the outer clutch. The input shafts 20, 22 comprise ends 5 that are connected to the two clutch discs 8, 10. These ends are also termed as clutch disc ends 5 of the input shafts 20, 22.

An outer diameter around the inner clutch disc 8 is larger than that of the outer clutch disc 10. Correspondingly, an outer diameter of the inner clutch disc 8 is larger than an outer diameter of the outer clutch disc 10.

The above-mentioned nine torque flow paths not only provide viable solutions to generate nine gear speeds of the DCT 1, but also offer possibilities of switching from one gear to the another efficiently. The gear switching can be achieved by switching between the two input shafts, between idler gearwheels of different gear speeds, or in combination of both.

In providing gear meshing or combing for torque transmission, less number of gear tooth engagement, that is gear engagement, is preferred. The less number of gear tooth engagement generates lower noise and provides more efficient torque transmission. Examples of the less gear tooth engagement are provided in FIGS. 2-10.

The DCT 1 drives the gearwheel groups of the second gear speed and the reverse gear speed by different input shafts 20, 22. A vehicle with the DCT 1 can move between a slow forward mode and a slow backward mode by alternating engagements between the two clutch discs 8, 10. The DCT 1 enables the vehicle to move back and forth quickly with little loss of the transmission power or gearwheel momentum because the relevant gearwheels are not stopped in the process. This scheme helps in many situations in which a wheel of the vehicle is stuck in a slippery road such as a snow hole or a mud hole. The vehicle can then be swayed free just by switching between the two clutch discs 8, 10.

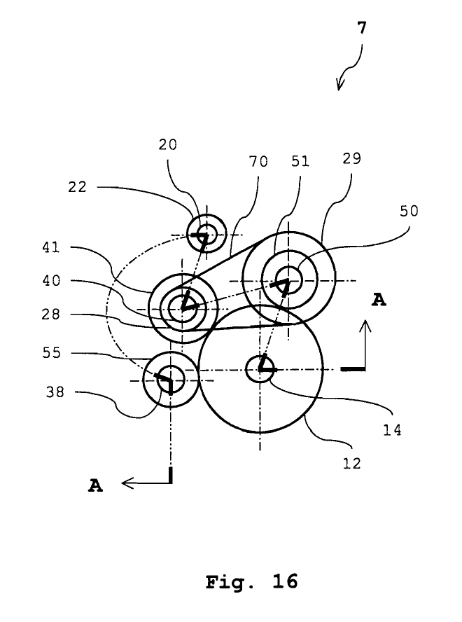

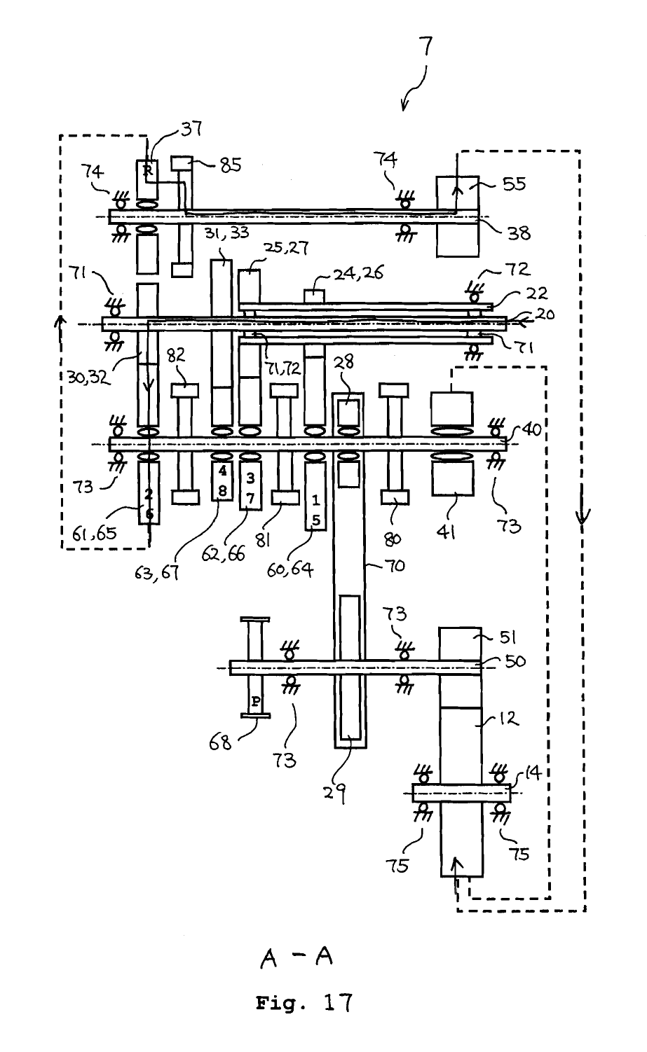

FIGS. 16-17 illustrate a second embodiment of the application. The embodiment includes parts that are similar to the parts of previously described embodiment in FIGS. 1-15. The similar parts are labeled with the same reference numbers. Descriptions of the similar parts are hereby incorporated by reference unless specified otherwise as below.

FIG. 16 illustrates a front view of a second embodiment of a double clutch transmission 9 of the present application. FIG. 17 illustrates an expanded cross-section view of the second embodiment of the double clutch transmission 9. In particular, the reverse gear idler wheel 37 meshes with idler second gear 61, not the idler first gear 60. In FIG. 17, the single-sided coupling device 85 is placed on the right side of the reverse gear idler wheel 37.

Torque flow path of a reverse gear speed of the double-clutch transmission 7 starts from the solid input shaft 20. The solid input shaft 20 receives engine torque from the inner clutch disc 8 and transmits the torque via the fixed wheel second gear 30, the idler second gear 61, the reverse gear idler wheel 37, via the single-sided coupling device 85, via the reverse gear layshaft 38, via the reverse pinion 55, via the output gear wheel 12, to the output shaft 14.

The double-clutch transmission 7 enables rocking motion where the first gear speed and the reverse gear speed are driven by different input shafts 20, 22. These input shafts 20, 22 can be alternatively engaged for enabling a vehicle with the double-clutch transmission 7 to move back and forth with almost no loss of engine propulsion power and gearwheels momentum.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims, rather than by the examples given.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A double-clutch transmission, comprising:
an outer input shaft;
an inner input shaft and having at least a portion surrounded by the outer input shaft;
a first layshaft, a second layshaft and a third layshaft spaced apart from the inner input shaft and the outer input shaft and arranged in parallel to the inner input shaft and the outer input shaft;
a pinion mounted on at least one of the first layshaft, the second layshaft, or the third layshaft and meshing with an output gearwheel on an output shaft;
a plurality of gearwheels arranged on the first layshaft, the second layshaft, the third layshaft, the inner input shaft, and the outer input shaft, the plurality of gearwheels comprising a first gearwheel group, a second gearwheel group, a third gearwheel group, a fourth gearwheel group, a fifth gearwheel group, a sixth gearwheel group and a seventh gearwheel group that are adapted to provide seven forward gear speeds,
wherein the first gearwheel group comprises a fixed wheel first gear on one of the inner input shaft and the outer input shaft, meshing with an idler first gear on one of the first layshaft, the second layshaft, or the third layshaft and adapted to provide a first forward gear speed,
wherein the second gearwheel group comprises a fixed wheel second gear on one of the inner input shaft and the outer input shaft, meshing with an idler second gear on one of the first layshaft, the second layshaft, or the third layshaft and adapted to provide a second forward gear speed,
wherein the third gearwheel group comprising a fixed wheel third gear on one of the inner input shaft and the outer input shaft, meshing with an idler third gear on one of the first layshaft, the second layshaft, or the third layshaft and adapted to provide a third forward gear speed,
wherein the fourth gearwheel group comprises a fixed wheel fourth gear on one of the inner input shaft and the outer input shaft, meshing with an idler fourth gear on one of the first layshaft, the second layshaft, or the third layshaft and adapted to provide a fourth forward gear speed,
the fifth gearwheel group comprising a fixed wheel fifth gear on one of the inner input shaft and the outer input shaft, meshing with an idler fifth gear on one of the first layshaft, the second layshaft, or the third layshaft, and adapted to provide a fifth forward gear speed,
the sixth gearwheel group comprising a fixed wheel sixth gear on one of the inner input shaft and the outer input shaft, meshing with an idler sixth gear on one of the first layshaft, the second layshaft, or the third layshaft and adapted to provide a sixth forward gear speed,
the seventh gearwheel group comprising a fixed wheel seventh gear on one of the inner input shaft and the outer input shaft, meshing with an idler seventh gear on one of the first layshaft, the second layshaft, or the third layshaft and adapted to provide a seventh forward gear speed; and
a coupling device being mounted on one of the first layshaft, the second layshaft, or the third layshaft to selectively engage one of the idler first gear, the idler second gear, the idler third gear, the idler fourth gear, the idler fifth gear, the idler sixth gear, or the idler first gear, for outputting the seven gear speeds,
wherein the pinion comprises a first pinion mounted on the first layshaft via a bearing.

2. The double-clutch transmission according to claim 1 further comprising a first sprocket and a second sprocket on a separate layshaft of the first layshaft, the second layshaft, or the third layshaft that are coupled together via a chain.

3. The double-clutch transmission according to claim 1, wherein a plurality of idler gearwheels of odd forward speeds and a plurality of idler gearwheels of even forward speeds are driven by a plurality different input shafts.

4. The double-clutch transmission according to claim 1, further comprising a park-lock gearwheel fixed onto one of that the first layshaft, the second layshaft, or the third layshaft that carries the pinion.

5. The double-clutch transmission according to claim 1, further comprising an inner clutch disc connected to the inner input shaft and an outer clutch disc connected to the outer input shaft.

6. The double-clutch transmission according to claim 1, wherein at least two of the plurality of idler gearwheels of the seven forward gear speeds share a same gearwheel.

7. The double-clutch transmission according to claim 1, further comprising a reverse gearwheel group that comprises a gearwheel on one of the inner input shaft and the outer input shaft and meshing with at least one of the plurality of idler gearwheels on the first layshaft, the second layshaft, or the third layshaft and adapted to provide a reverse gear speed.

8. The double-clutch transmission according to claim 7, wherein the reverse gear speed is provided by an input shaft that is different from that of a low gear speed.

9. The double-clutch transmission according to claim 1, wherein at least two of the plurality of idler gearwheels of the seven gear speeds are mounted on one of the first layshaft, the second layshaft, or the third layshaft.

10. The double-clutch transmission according to claim 1, wherein the plurality of idler gearwheels are mounted on a same layshaft of the first layshaft, the second layshaft, or the third layshaft.

11. The double-clutch transmission according to claim 1, further comprising an eighth gearwheel group that comprises a fixed wheel eighth gear on one of the inner input shaft and the outer input shaft, meshing with an idler eighth gear on one of the first layshaft, the second layshaft, or the third layshaft and adapted to provide an eighth forward gear speed.

12. The double-clutch transmission according to claim 1, further comprising a plurality of bearings adapted to support the first layshaft, the second layshaft, or the third layshaft and the output shaft, at least one of the plurality of bearings adapted to be provided next to the pinion or the output gearwheel.

13. The double-clutch transmission according to claim 1, further comprising three pinions mounted onto the first layshaft, the second layshaft, or the third layshaft and mesh with the output gearwheel and adapted to output a drive torque to a torque drain.
